(19) United States
(12) Patent Application Publication
(10) Pub. No.: US 2015/0219450 A1
(43) Pub. Date: Aug. 6, 2015

(54) FILM THICKNESS MEASUREMENT DEVICE

(71) Applicant: Sharp Kabushiki Kaisha, Osaka-shi, Osaka (JP)

(72) Inventors: Norikazu Hohshi, Osaka-shi (JP); Hidekazu Sakagami, Yao-shi (JP); Narumi Harada, Yao-shi (JP); Chiaki Yamawaki, Yao-shi (JP)

(21) Appl. No.: 14/420,714

(22) PCT Filed: Aug. 23, 2013
(86) PCT No.: PCT/JP2013/072583

§ 371 Date: Feb. 10, 2015

(30) Foreign Application Priority Data
Aug. 31, 2012 (JP) 2012-192030

(51) Int. Cl. G01B 15/02; G01N 23/223; G01N 23/205

(52) U.S. Cl. CPC G01B 15/02; G01N 23/2055; G01N 23/223

(57) ABSTRACT

A measurement head (23) irradiates a film (12) of a product substrate (10) with primary X-rays to detect fluorescent X-rays generated from the film (12). Analysis means (33) obtains thickness of the film (12) from intensity of the fluorescent X-rays detected by the measurement head (23).

### TECHNICAL FIELD

The present invention relates to a film thickness measurement device that measures thickness of a film on a substrate.

### BACKGROUND ART

In general, there has been a film thickness measurement device described in Japanese Unexamined Patent Application Publication No. 11-6804 (PTL 1). This film thickness measurement device measures thickness of a film on a substrate by using an X-ray reflectance method.

However, in the aforementioned film thickness measurement device according to the related art, because of using the X-ray reflectance method, there is a problem that a spot diameter of an X-ray on a film becomes large, it is difficult to measure a minute region of the film on the substrate, and the accuracy in measuring film thickness may be insufficient. Moreover, the X-ray reflectance method has a problem that a measurement time becomes long. Therefore, the X-ray reflectance method is unsuitable particularly for measurement of thickness of a film on a large-sized substrate.

### CITATION LIST

### Patent Literature

PTL 1: Japanese Unexamined Patent Application Publication No. 11-6804

### SUMMARY OF INVENTION

### Technical Problem

Accordingly, an object of the present invention is to provide a film thickness measurement device capable of improving the accuracy in measuring film thickness and reducing time for measuring film thickness.

### Solution to Problem

In order to solve the aforementioned problem, a film thickness measurement device according to the invention includes: a base; a substrate stage which is provided on the base and on which a product substrate having a film is placed; a gantry that extends in a first direction with respect to the substrate stage and is installed in the base so as to be movable in a second direction with respect to the substrate stage; a slider that is installed in the gantry so as to be movable in the first direction; a measurement head that is fixed to the slider and irradiates a film of the product substrate placed on the substrate stage with primary X-rays to detect fluorescent X-rays generated from the film; and analysis means that obtains thickness of the film from intensity of the fluorescent X-rays detected by the measurement head.

Here, the product substrate has the substrate and the film having one or more layers, which is formed on the substrate.

According to the film thickness measurement device of the present invention, the measurement head irradiates the film of the product substrate with the primary X-rays to detect the fluorescent X-rays generated from this film, and the analysis means obtains the thickness of the film from the intensity of the fluorescent X-rays detected by the measurement head.

In this manner, since the film thickness is obtained by a fluorescent X-ray analysis method, it is possible to measure a minute region of the film of the product substrate and to improve accuracy in measuring the film thickness. Further, the fluorescent X-ray analysis method makes it possible to reduce time for measuring the film thickness compared to when an X-ray reflectance method is ised.

Furthermore, since the measurement head is movable in the first direction and the second direction with respect to the substrate stage, it is possible to measure the film thickness at a plurality of points of the product substrate using this measurement head. Accordingly, the film thickness measurement device of the present invention is suitable for measuring the film thickness of a large-sized product substrate.

Moreover, the film thickness measurement device of one embodiment includes: a camera that is fixed to the slider and detects an alignment mark of the product substrate placed on the substrate stage; substrate position correction means that corrects position information of the product substrate placed on the substrate stage based on a detection result of the camera; a displacement sensor that is fixed to the slider and measures distance to the product substrate placed on the substrate stage; and head position adjustment means that adjusts a position of the measurement head based on a measurement value of the displacement sensor so that distance between the product substrate placed on the substrate stage and the measurement head has a predetermined constant value.

According to the film thickness measurement device of this embodiment, the camera detects the alignment mark of the product substrate placed on the substrate stage, and the substrate position correction means corrects the position information of the product substrate placed on the substrate stage based on this detection result of the camera. The displacement sensor then measures the distance to the product substrate placed on the substrate stage, and based on this measurement value of the displacement sensor, the head position adjustment means adjusts the position of the measurement head so that the distance between the product substrate placed on the substrate stage and the measurement head has the constant value.

In this manner, since the position of the product substrate is adjusted to thereby adjust the distance between the product substrate and the measurement head to the constant value before measuring the film thickness using the measurement head, it is possible to further improve the accuracy in measuring the film thickness of the product substrate.

### Advantageous Effects of Invention

According to the film thickness measurement device of the present invention, since the measurement head irradiates the film of the product substrate with the primary X-rays to detect the fluorescent X-rays generated from the film, and the analysis means obtains the thickness of the film from the intensity of the fluorescent X-rays detected by the measurement head, it is possible to improve the accuracy in measuring the film thickness and to reduce time for measuring the film thickness.

### BRIEF DESCRIPTION OF DRAWINGS

FIG. 1 is a plan view illustrating a film thickness measurement device of one embodiment of the present invention.

FIG. 2 is a side view of the film thickness measurement device as viewed in an arrow U direction in FIG. 1.

FIG. 3 is an explanatory view for explaining operation of a displacement sensor.

FIG. 4 is an explanatory view for explaining operation of a measurement head.

FIG. 5 is an explanatory view for explaining a state in which fluorescent X-rays are generated by irradiation of primary X-rays.

FIG. 6A is a table illustrating a relation between X-ray intensity and film thickness in a titanium film and a molybdenum film.

FIG. 6B is a graph in which data in FIG. 6A is plotted.

### DESCRIPTION OF EMBODIMENTS

The present invention will be described in detail below with an embodiment illustrated in the figures.

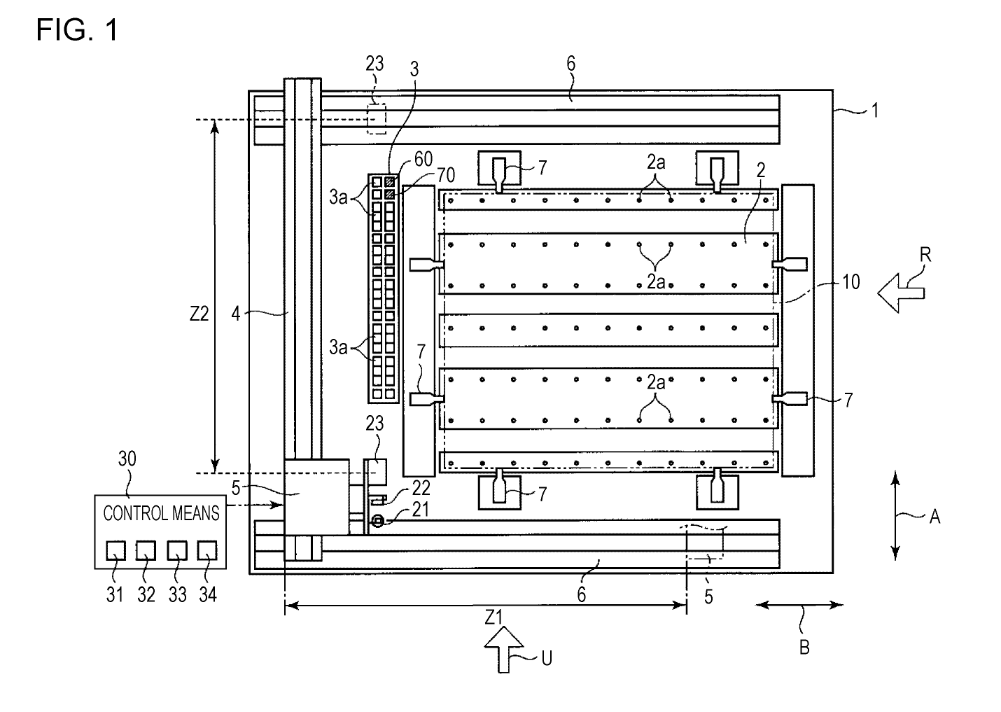

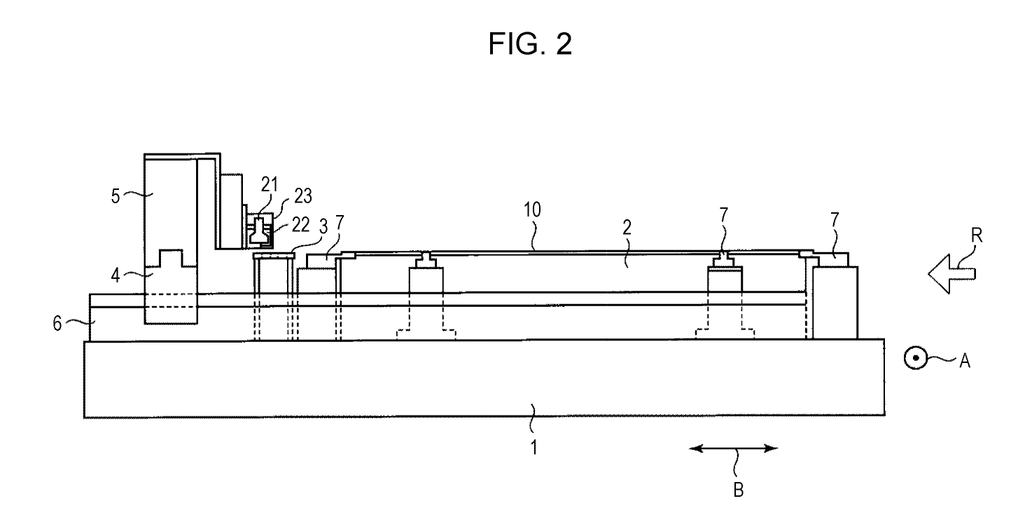

FIG. 1 is a plan view illustrating a film thickness measurement device of one embodiment of the present invention. FIG. 2 is a side view as viewed in an arrow U direction in FIG. 1. As illustrated in FIG. 1 and FIG. 2, this film thickness measurement device has a base 1, a substrate stage 2, a calibration stage 3, a gantry 4, a slider 5, a plurality of measurement equipment 21, 22 and 23, and control means 30.

The substrate stage 2 is provided on the base 1 and composed of a plurality of divided stages. A product substrate 10 in which a film is formed is placed on the substrate stage 2.

A plurality of air holes 2a are provided on the substrate stage 2, and the product substrate 10 is able to be closely adhered to the substrate stage 2 by taking in air from these air holes 2a, while the product substrate 10 is able to be floated from the substrate stage 2 by blowing air from the air holes 2a.

The product substrate 10 is, for example, a liquid crystal TFT used for a liquid crystal display. This product substrate 10 has a substrate and a film having one or more layers, which is formed on this substrate. The film is formed on the substrate, for example, with a sputtering method, a vapor deposition method or a plating method. The substrate is, for example, a glass substrate, and the film is, for example, a metal film of aluminum, titanium, tungsten, molybdenum or the like.

The calibration stage 3 is provided on the base 1 and provided separately from the substrate stage 2. This calibration stage 3 is provided with a plurality of concave units 3a, various types of calibration samples 60 and 70 are embedded in these concave units 3a, and calibration of the measurement equipment 21, 22 and 23 is performed by using these calibration samples 60 and 70.

The gantry 4 extends in a first direction with respect to the substrate stage 2 and the calibration stage 3. The gantry 4 is installed in the base 1 so as to be movable in a second direction with respect to the substrate stage 2 and the calibration stage 3. The first direction refers to an arrow A direction and the second direction refers to an arrow B direction. The first direction and the second direction are orthogonal with each other.

That is, two rail units 6 and 6 which extend in the second direction (arrow B direction) are provided on the base 1. These two rail units 6 and 6 are arranged so as to place the substrate stage 2 and the calibration stage 3 therebetween. The gantry 4 is laid across these two rail units 6 and 6 and is movable in the second direction along these rail units 6 and 6.

The slider 5 is installed in the gantry 4 so as to be movable in the first direction (arrow A direction). To this slider 5, a camera 21, a displacement sensor 22 and a measurement head 23 as the measurement equipment are fixed.

Further, the measurement equipment 21, 22 and 23 are able to cover an entire range of the substrate stage 2 and the calibration stage 3 in the second direction (arrow B direction) by a movable range Z1 of the gantry 4. In addition, the measurement equipment 21, 22 and 23 are able to cover an entire range of the substrate stage 2 and the calibration stage 3 in the first direction (arrow A direction) by a movable range Z2 of the slider 5.

The control means 30 has substrate position correction means 31, head position adjustment means 32, analysis means 33, and measurement equipment calibration means 34.

The camera 21 detects an alignment mark of the product substrate 10 placed on the substrate stage 2. This alignment mark is a mark which is able to be judged by the camera 21, and is provided, for example, at four corners of the product substrate 10.

The substrate position correction means 31 corrects position information of plane directions (first and second directions) of the product substrate 10 placed on the substrate stage 2 based on a detection result of the camera 21. Specifically, the base 1 is provided with a plurality of clamps 7 so as to press each surrounding side of the product substrate 10. After the product substrate 10 is fixed at a predetermined position by the clamps 7, the alignment mark is detected by the camera 21, and based on this detection result, the position information of the product substrate 10 is corrected by the substrate position correction means 31.

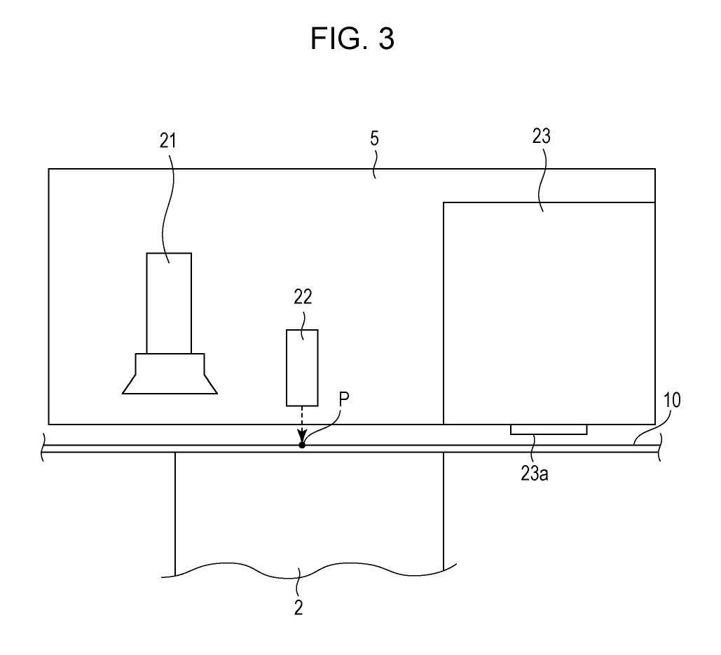

As illustrated in FIG. 3, the displacement sensor 22 measures distance in a height direction to the product substrate 10 placed on the substrate stage 2. The displacement sensor 22 measures distance to a predetermined measurement point P of the product substrate 10 by using rays such as, for example, infrared rays.

The head position adjustment means 32 adjusts a position in a height direction of the measurement head 23 based on a measurement value of the displacement sensor 22 so that distance between the product substrate 10 placed on the substrate stage and the measurement head 23 has a predetermined constant value. Specifically, distance in the height direction between the measurement point P of the product substrate 10 and a light reception and emission unit 23a of the measurement head 23 is adjusted so as to be 2 mm±30 μm.

Moreover, after adjusting the position in the height direction of the measurement head 23, the head position adjustment means 32 moves the measurement head 23 to a position where the measurement head 23 is able to measure the measurement point P of the product substrate 10.

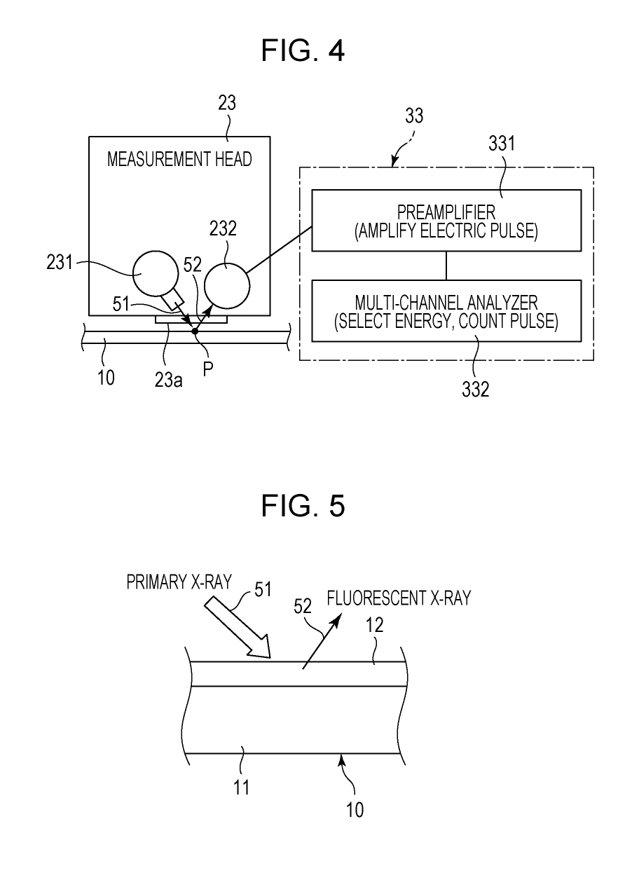

As illustrated in FIG. 4, the measurement head 23 has an X-ray irradiation unit 231 and a fluorescent X-ray detection unit 232.

The X-ray irradiation unit 231 irradiates the measurement point P of the product substrate 10 with primary X-rays 51 from the light reception and emission unit 23a. The primary X-rays 51 are, for example, rhodium, molybdenum, tungsten or the like. Then, as illustrated in FIG. 5, a film 12 on a substrate 11 of the product substrate 10 generates fluorescent X-rays 52 by irradiation of the primary X-rays 51.

The fluorescent X-ray detection unit 232 detects the fluorescent X-rays 52, which are generated from the film 12, from the light reception and emission unit 23a. The fluorescent X-ray detection unit 232 is, for example, a silicon drift detector.

The analysis means 33 obtains thickness of the film 12 from intensity of the fluorescent X-rays 52 detected by the measurement head 23. Specifically, the analysis means 33 has a preamplifier 331 and a multi-channel analyzer (hereinafter, referred to as MCA) 332.

The preamplifier 331 amplifies an electric signal output from the fluorescent X-ray detection unit 232. The MCA 332 analyzes the electric signal amplified with the preamplifier 331. At the MCA 332, by selecting energy output from the fluorescent X-ray detection unit 232 to count pulse, X-ray intensity of an element which constitutes the film 12 is obtained. Then, based on this X-ray intensity, the thickness of the film 12 is obtained from known data. Note that, since the MCA 332 is used, it is possible to detect a foreign substance and an impure substance which are included in the film 12.

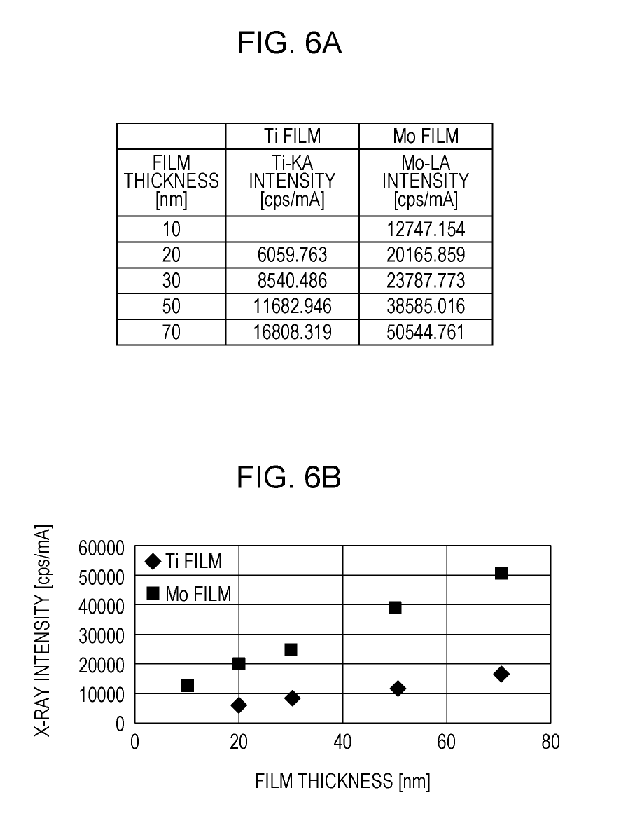

For example, when the film 12 is a titanium film or a molybdenum film, a relation between the X-ray intensity and the film thickness becomes a relation as illustrated in FIG. 6A and FIG. 6B.

Note that, though description has been given above for measurement of the thickness of the film having a single layer (FIG. 5), it is also possible to measure the thickness of a film having a plurality of layers. In this case, fluorescent X-rays generated from each film are detected by the measurement head 23, and, by the analysis means 33, X-ray intensity of each element constituting each film is obtained, and the thickness of each film is obtained based on this X-ray intensity. Furthermore, it is also possible to obtain a composition ratio of each element from this X-ray intensity of each element.

As illustrated in FIG. 1, the measurement equipment calibration means 34 moves the measurement equipment 21, 22 and 23 to the calibration stage 3 to perform calibration of the measurement equipment 21, 22 and 23. The calibration of the measurement equipment 21, 22 and 23 is performed at a predetermined interval. This predetermined interval is, for example, at every predetermined time interval such that calibration is performed once a day or at every predetermined processing number such that calibration is performed after the film thickness of the predetermined number of the product substrates 10 is measured.

The first calibration sample 60 and the second calibration sample 70 are disposed in the calibration stage 3. The first calibration sample 60 is, for example, a sample for adjusting a gain of the fluorescent X-ray detection unit 232 of the measurement head 23. The second calibration sample 70 is, for example, a sample for adjusting an offset amount of each measurement equipment 21, 22 and 23.

In addition, the calibration of the measurement equipment 21, 22 and 23 is performed by using the first and the second calibration samples 60 and 70.

Next, operation of the film thickness measurement device of the aforementioned configuration will be described.

As illustrated in FIG. 1, first, the product substrate 10 is conveyed onto the substrate stage 2 from a right direction (arrow R direction) of the film thickness measurement device. The product substrate 10 conveyed onto the substrate stage 2 is fixed at a predetermined position by the clamps 7. Then, the alignment mark is detected by the camera 21, and based on this detection result, position information of the product substrate 10 is corrected by the substrate position correction means 31.

Thereafter, at a first measurement point among a plurality of measurement points of the product substrate 10, distance in a height direction between the first measurement point and the displacement sensor 22 is measured by the displacement sensor 22. Based on this measurement value, the head position adjustment means 32 then adjusts a position in the height direction of the measurement head 23 so that distance between the first measurement point and the measurement head 23 has a constant value.

Subsequently, the measurement head 23 is moved immediately above the first measurement point by the head position adjustment means 32 and irradiates the film of the product substrate 10 with the primary X-rays to detect the fluorescent X-rays generated from this film. The analysis means 33 then obtains the thickness of the film from the intensity of these detected fluorescent X-rays.

Furthermore, for different measurement points of the product substrate 10 as well, the film thickness of the different measurement points is measured by the measurement head 23 after adjusting height of the measurement head 23 in the same manner.

In this manner, the film thickness of all measurement points of the product substrate 10 is measured, and based on this measurement result, whether or not the product substrate 10 is a defective product is judged.

Subsequently, the measurement equipment calibration means 34 moves the measurement equipment 21, 22 and 23 to the calibration stage 3 at a predetermined interval to perform calibration of the measurement equipment 21, 22 and 23.

According to the film thickness measurement device of the aforementioned configuration, the measurement head 23 irradiates the film 12 of the product substrate 10 with the primary X-rays 51 to detect the fluorescent X-rays 52 generated from this film 12, and the analysis means 33 obtains the thickness of the film 12 from the intensity of the fluorescent X-rays 52 detected by the measurement head 23.

In this manner, since the film thickness is obtained with a fluorescent X-ray analysis method, it is possible to measure a minute region of the film 12 of the product substrate 10 and to improve the accuracy in measuring the film thickness. Further, the fluorescent X-ray analysis method makes it possible to reduce time for measuring the film thickness compared to an X-ray reflectance method.

Furthermore, since the measurement head 23 is movable in the first direction and the second direction with respect to the substrate stage 2, it is possible to measure the film thickness at a plurality of points of the product substrate 10 with this measurement head 23. Accordingly, the film thickness measurement device of the present invention is suitable for measurement of the film thickness of the large-sized product substrate 10.

In addition, the camera 21 detects the alignment mark of the product substrate 10 placed on the substrate stage 2, and based on this detection result of the camera 21, the substrate position correction means 31 corrects position information of the product substrate 10 placed on the substrate stage 2. The displacement sensor 22 then measures distance to the product substrate 10 placed on the substrate stage 2, and based on this measurement vale of the displacement sensor 22, the head position adjustment means 32 adjusts the position of the measurement head 23 so that distance between the product substrate 10 placed on the substrate stage 2 and the measurement head 23 has a constant value.

In this manner, since the position of the product substrate 10 is adjusted to thereby adjust the distance between the product substrate 10 and the measurement head 23 to the constant value before measuring the film thickness with the measurement head 23, it is possible to further improve the accuracy in measuring the film thickness of the product substrate 10.

Note that, the present invention is not limited to the aforementioned embodiment. For example, only the measurement head 23 may be provided by omitting the camera 21 and the displacement sensor 22. Moreover, only the substrate stage 2 may be provided by omitting the calibration stage 3.

In addition, the first direction in which the gantry 4 extends and the second direction in which the gantry 4 moves may not be orthogonal but intersect with each other.

Further, the number of the cameras 21, the displacement sensors 22 and the measurement heads 23 may be plural and not limited to one.

Furthermore, though two calibration samples 60 and 70 are disposed in the calibration stage 3, the number of calibration samples may freely be increased or decreased. In addition, the calibration samples may be in other type, and may be calibration samples for calibrating drift of the X-ray intensity, for example.

Moreover, the film thickness measurement device of the present invention may measure film thickness of a small-sized product substrate, and may measure film thickness of a semiconductor substrate of organic EL or the like other than the liquid crystal TFT.

### REFERENCE SIGNS LIST

1 base
2 substrate stage
3 calibration stage
4 gantry
5 slider
6 rail unit
7 clamp
10 product substrate
21 camera
22 displacement sensor
23 measurement head
30 control means
31 substrate position correction means
32 head position adjustment means
33 analysis means
34 measurement equipment calibration means
60 first calibration sample
70 second calibration sample
A first direction
B second direction

1. A film thickness measurement device, comprising:
a base (1);
a substrate stage (2) which is provided on the base (1) and on which a product substrate (10) having a film is placed;
a gantry (4) that extends in a first direction (A) with respect to the substrate stage (2) and is installed in the base (1) so as to be movable in a second direction (B) with respect to the substrate stage (2);
a slider (5) that is installed in the gantry (4) so as to be movable in the first direction (A);
a measurement head (23) that is fixed to the slider (5) and irradiates a film (12) of the product substrate (10) placed on the substrate stage (2) with primary X-rays to detect fluorescent X-rays generated from the film (12); and
analysis means (33) that obtains thickness of the film (12) from intensity of the fluorescent X-rays detected by the measurement head (23).

2. The film thickness measurement device according to claim 1, further comprising:
a camera (21) that is fixed to the slider (5) and detects an alignment mark of the product substrate (10) placed on the substrate stage (2);
substrate position correction means (31) that corrects position information of the product substrate (10) placed on the substrate stage (2) based on a detection result of the camera (21);
a displacement sensor (22) that is fixed to the slider (5) and measures distance to the product substrate (10) placed on the substrate stage (2); and
head position adjustment means (32) that adjusts a position of the measurement head (23) based on a measurement value of the displacement sensor (22) so that distance between the product substrate (10) placed on the substrate stage (2) and the measurement head (23) has a predetermined constant value.
